(19) United States
(12) Patent Application Publication
(10) Pub. No.: US 2018/0326284 A1
(43) Pub. Date: Nov. 15, 2018

(54) SYSTEMS AND METHODS FOR CRICKET/BASEBALL GAME SCORING AND UMPIRING

(71) Applicant: Cricketronics Private Limited, Chennai (IN)

(72) Inventors: Mahesh B. Mariappan, Chennai (IN); Nagarajan Soodammani, Chennai (IN)

(21) Appl. No.: 15/795,250

(22) Filed: Oct. 26, 2017

Related U.S. Application Data
(60) Provisional application No. 62/412,856, filed on Oct. 26, 2016.

(51) Int. Cl. A63B 71/06; H04L 29/08; A63B 67/00; A63B 60/46

(52) U.S. Cl. CPC A63B 71/0605; H04L 67/1095; A63B 67/002; A63B 2102/20; A63B 71/0622; H04L 67/12; A63B 60/46

(57) ABSTRACT

A system for automatically scoring and umpiring a cricket or baseball game without human scorers or umpires. The system collects data from smart sports equipment and automatically updates the score and performs umpiring functions. The system synchronizes smart equipment used during gameplay, obtains sensor data from the smart equipment, performs signal processing and pattern recognition on the sensor data, and performs cricketing and baseball tasks. The system may detect tosses, detect calls, infer who won the toss, capture whether batting or fielding is chosen first, identify players, authenticate a valid field state to begin game play, identify the batsman taking guard, signal the commencement of the game, detect a valid ball that is bowled, track the scores, understand the end of an over and falling of wickets, and/or declare the winner. The system enables one to conduct and administer a large number of cricket or baseball games without human umpires.

### BACKGROUND

The present disclosure relates to the field of sports technology and automatic scoring and umpiring.

### BRIEF DESCRIPTION OF THE DRAWINGS

FIG. 1A shows a valid game state of a cricket game and some of the modules in an embodiment of the present disclosure.

FIG. 1B shows a valid baseball game state.

FIG. 2 shows automatic player identification in an embodiment of the present disclosure.

FIGS. 3A-3D show automatic batsman's guard detection in an embodiment of the present disclosure.

FIG. 4 shows fall of wicket determination in an embodiment of the present disclosure.

FIG. 5 shows the toss module of the disclosure in an embodiment of the present disclosure.

FIG. 6 shows fielding restrictions compliance authentication in an embodiment of the present disclosure.

FIG. 7 shows the over change detection module in an embodiment of the present disclosure.

FIG. 8 shows a smart cricket bat that has a built-in electronics unit including sensors and a microprocessor circuit board in an embodiment of the present disclosure.

FIG. 9 shows a smart cricket ball and other cricketing equipment with built-in electronics units including sensors and a microprocessor circuit board in an embodiment of the present disclosure.

FIG. 10 shows a smart wrist band containing a biometric identification module and a wireless communications transmitter in an embodiment of the present disclosure.

FIG. 11 shows a smart cricket ball with voice activation and feedback modules in an embodiment of the present disclosure.

FIG. 12 shows smart baseball equipment containing embedded sensor electronics in an embodiment of the present disclosure.

FIG. 13A shows a cricket runout detection subsystem using a laser and motion sensing bails synchronized with computing system and time server in an embodiment of the present disclosure.

FIG. 13B shows an alternative embodiment where the laser beam unit is embedded within the stumps.

FIG. 14 shows cricket batting edge detection using force sensor strips on the bat.

FIG. 15 shows a catch detection module in cricket/baseball.

FIG. 16 shows a wide detection module in cricket.

FIGS. 17A and 17B show embodiments of no-ball detection in cricket.

FIG. 18 shows unfavorable conditions for play detector.

FIG. 19 shows a cricket bat with a display unit with a web browser to browse cloud and online data.

FIG. 20 shows a cricket bat face orientation detection module, which warns a batsman about the batsman's batting stance if an anomalous stance is detected.

FIG. 21 shows a 22-yard pitch and crease marking stump.

FIG. 22 shows a solar-powered cricket bat in an embodiment of the present disclosure.

FIG. 23 shows a piezoelectric rechargeable cricket bat that works based on how hard and how many times a batsman is hitting the ball.

FIG. 24 shows a cricket bat with a detachable pico projection display.

FIG. 25 shows a cricket bat with a foldable, flip-type display.

FIG. 26 shows an audio cricket bat which plays a song after the batsman hits a ball with a force that is above a specified minimum threshold.

FIG. 27 shows a cricket bat with running tickers that keep track of the batsman's performance metrics.

### DETAILED DESCRIPTION

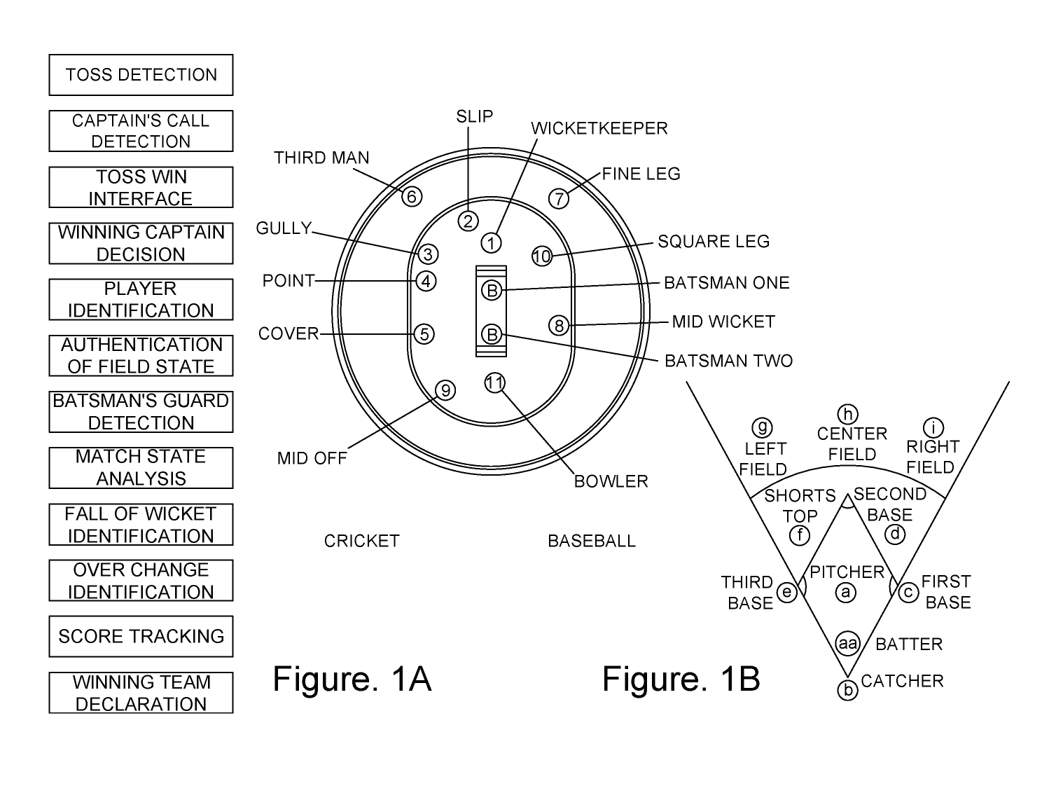

FIG. 1A shows a valid game state of a cricket game and modules in an embodiment of the present disclosure. The valid field state instance shown contains the following players: a wicketkeeper 1, a slip 2, a gully 3, a point 4, a cover 5, a third man 6, a fine leg 7, a mid-wicket 8, a mid-off 9, a square leg 10, a bowler 11, a first batsman A, and a second batsman B. FIG. 1A also shows the cricket modules of the disclosure. According to embodiments, the cricket modules include any combination of the following modules: toss detection, captain's call detection, toss win inference, winning captain decision, player identification, authentication of field state, batsman's guard detection, game state analysis, fall of wicket identification, over-change identification, score tracking, winning team declaration, and associated edge cases. FIG. 1B shows a valid baseball game state with the following players: pitcher a, batter aa, catcher b, first baseman c, second baseman d, third baseman e, shortstop f, left fielder g, center fielder h, and right fielder i.

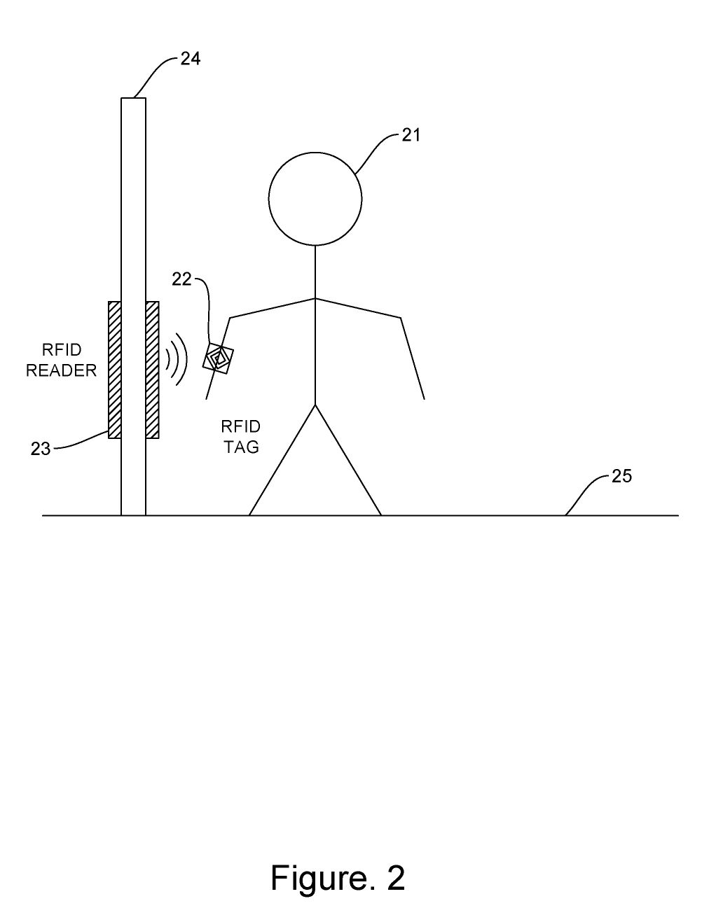

FIG. 2 shows automatic player identification in an embodiment of the present disclosure using Radio Frequency Identification (RFID) reader 23 affixed to the field entry gate 24 and the player(s) 21 wearing RFID tags 22. As the player(s) 21 enter the field 25, the system takes cognizance of the eleven players belonging to the bowling side and the two batsmen in the game of cricket. In the game of baseball, the system takes cognizance of the batter, first baseman, second baseman, third baseman, pitcher, catcher, shortstop, left fielder, center fielder, and the right fielder playing the baseball game.

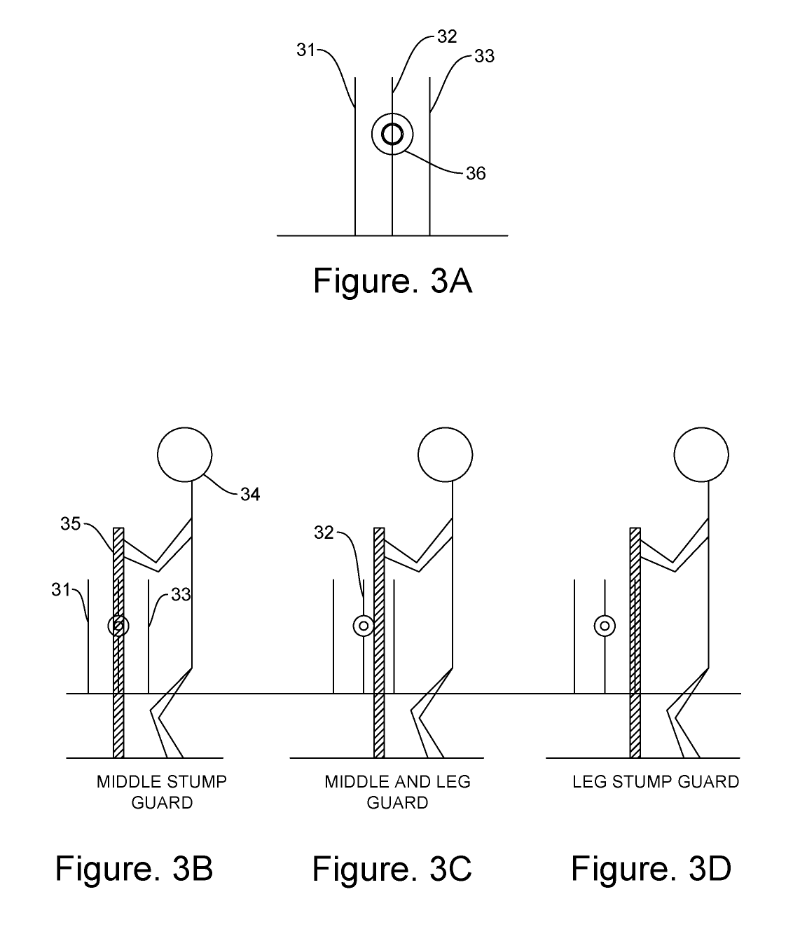

FIG. 3A shows automatic batsman's guard detection in the game of cricket, in an embodiment of the present disclosure. FIG. 3B shows a middle stump guard where a batsman 34 holds his bat 35 in front of middle stump 32. FIG. 3C shows a middle and leg guard where a batsman 34 holds his bat 35 in between the middle stump 32 and the leg stump 33. FIG. 3D shows a leg stump guard where a batsman 34 holds his bat 35 in front of the leg stump 33. A stump camera 36 captures and processes real-time video to detect the position of the batsman's bat in order to determine his choice of guard.

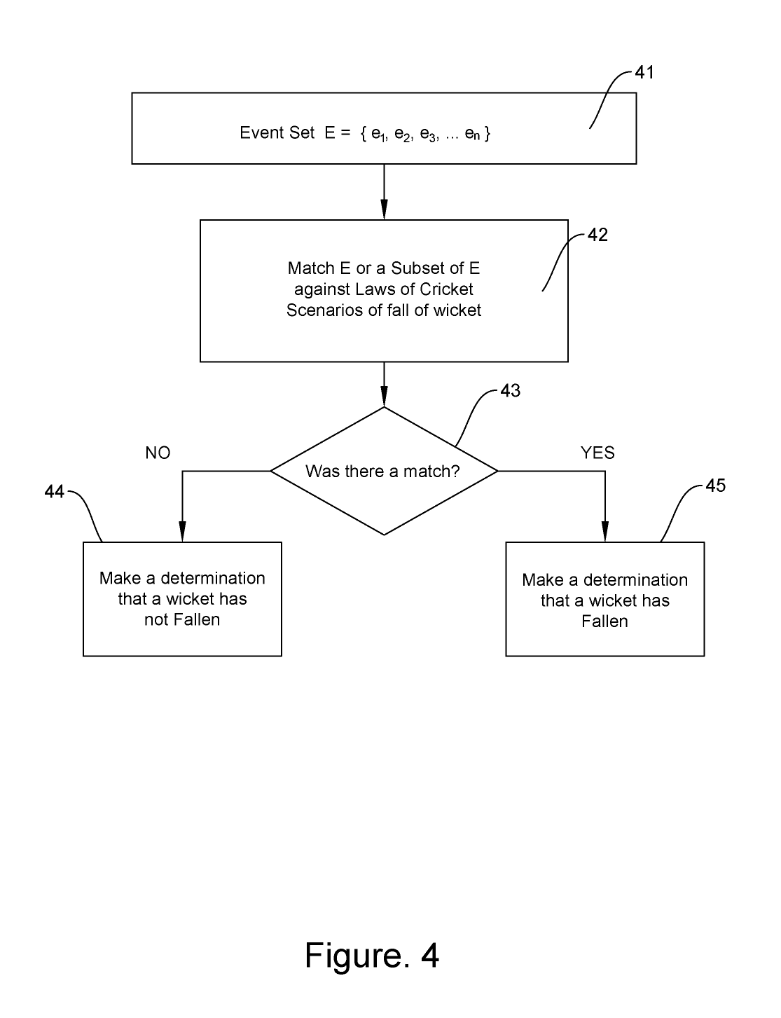

FIG. 4 shows a fall of wicket determination in cricket in an embodiment of the present disclosure. A wicket is said to have fallen when an event or a series of events occur, which together imply that a batsman has got out as per the laws or rules of cricket. The event set E={e1, e2 , e3, . . . , en} is captured by a plurality of sensors at block 41. E or a subset of E is matched against the laws of cricket relating to scenarios of fall of wicket at block 42. Decision block 43 checks if there was a positive match. If yes, then a determination is made that a wicket has fallen at block 45. If no, then the determination is made that a wicket has not fallen at block 44.

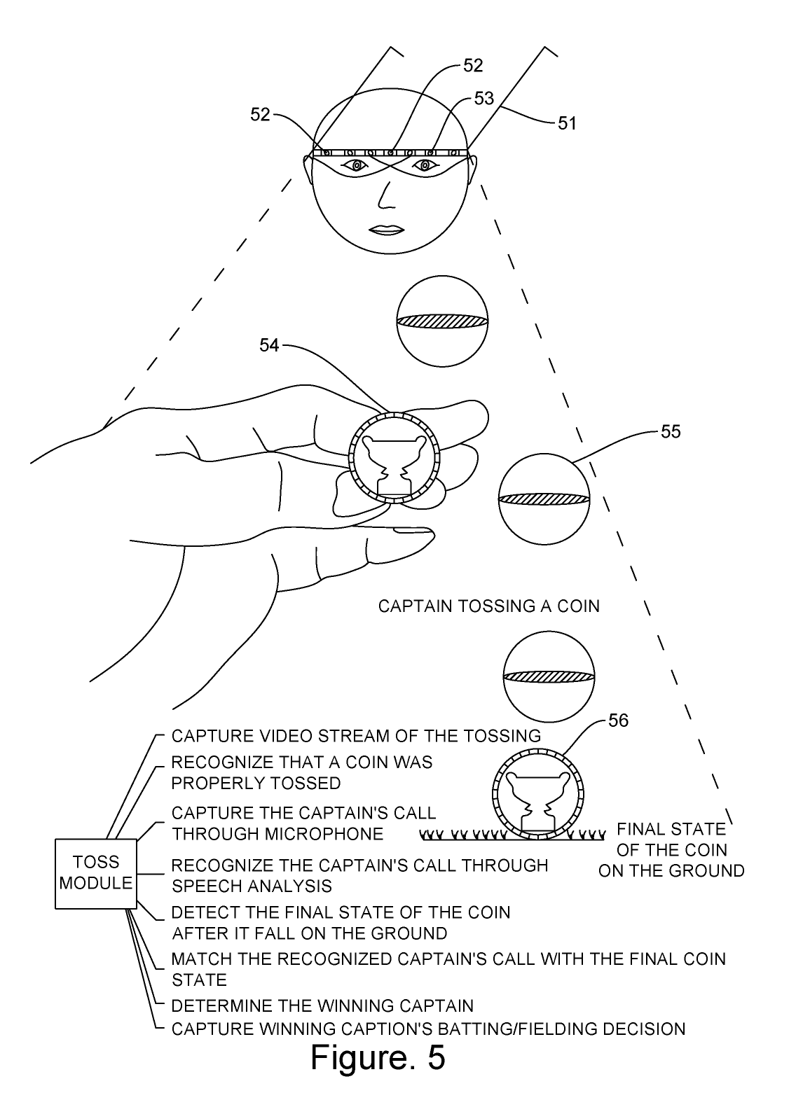

FIG. 5 shows the toss module of the system and its functions for cricket in an embodiment of the present disclosure. As illustrated in FIG. 5, wearable eyeglasses 51, which contain a camera array 52, a sensory array 53, and a microphone 52, are worn by any one of the captains at the toss. State 54 shows the initial state of the coin about to be tossed. State 55 shows the spinning coin in the air. State 56 shows the final state of the coin on the ground. The toss module may perform any combination of at least a portion of the following functions: capturing the video stream of the tossing, recognizing that a coin is being tossed properly, capturing the audio of the captain's call through the microphone attached to wearable eyeglasses, recognizing the captain's call through speech analysis, detecting the final state of the coin after it has fallen to the ground, matching the recognized captain's call with the final state of the coin on the ground, determining the winning captain, and capturing the winning captain's batting or fielding decision.

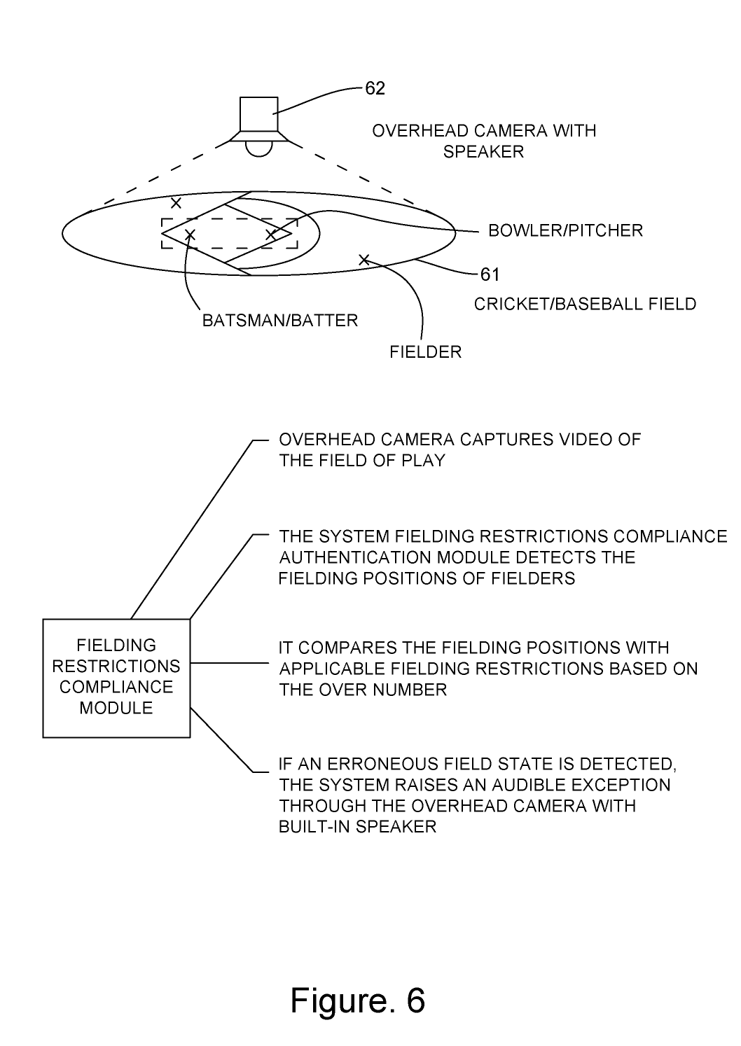

FIG. 6 shows a fielding restrictions compliance authentication module in an embodiment of the present disclosure for both cricket and baseball. This module uses an overhead camera 62 with a built-in speaker that captures a live video feed of the cricket/baseball ground 61. Through video analysis, this module detects the fielding positions of fielders and compares these positions to the applicable fielding restrictions based on the over number in cricket or the stage of the game in baseball. If an erroneous field state is detected, this module raises an audible alert through the built-in speaker of the overhead camera.

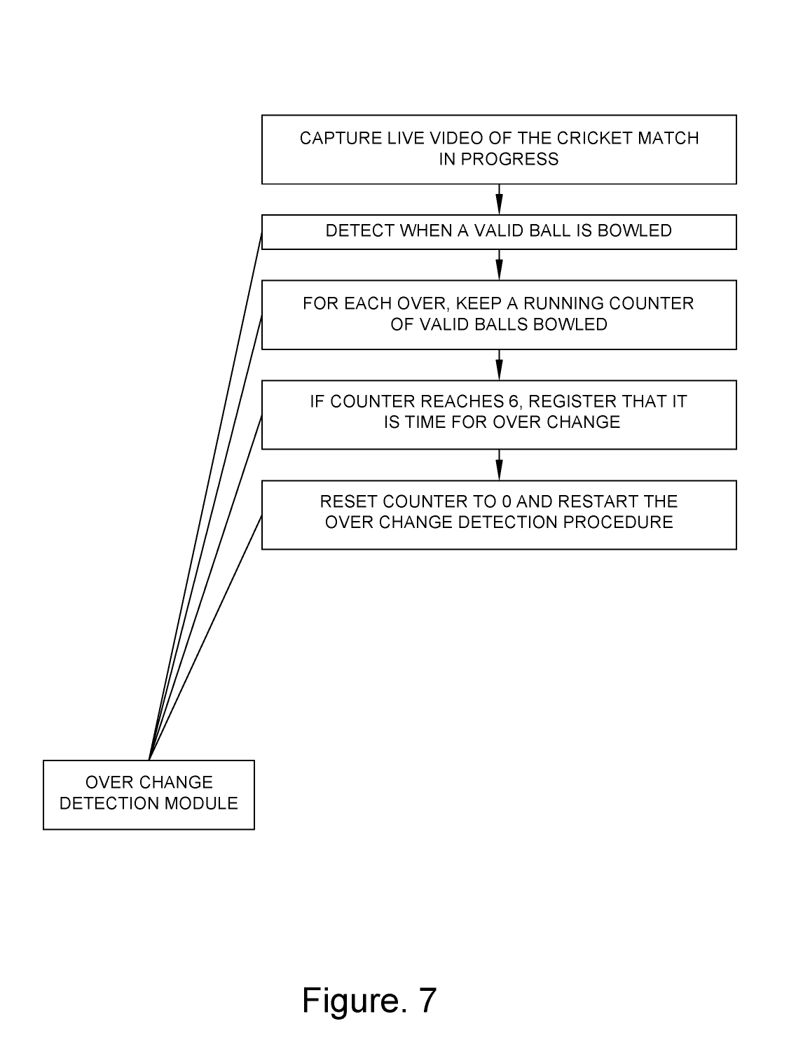

FIG. 7 shows the over change detection module in cricket in an embodiment of the present disclosure. This module may perform the following functions or functions similar to the following functions: a) capturing the live video of the cricket game in progress, b) detecting when a valid ball is bowled, c) for each over, keeping a running counter of valid balls bowled, d) if the running counter reaches a value of 6, registering that it is time for over change, and e) resetting the counter to 0 and restarting the over change detection procedure.

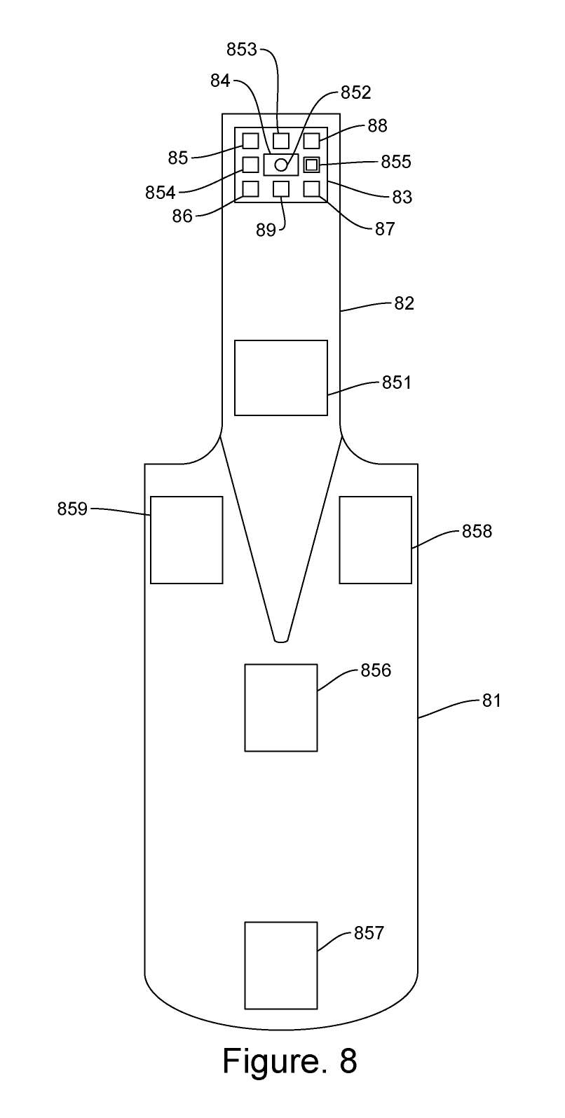

FIG. 8 shows a smart cricket bat 81 that has a built-in electronics unit 83 including various sensors and a microprocessor-based circuit board 84 in an embodiment of the present disclosure. The electronics unit 83 may include an accelerometer 85 that measures the acceleration or rate of change of velocity (at, for example, a particular location on the smart cricket bat 81), a gyroscope 86 for measuring angular velocity, a magnetometer 87 for measuring orientation with respect to the earth's magnetic field, a wireless communications module 88, such as a low-energy Bluetooth® module, a rechargeable battery unit 89, memory 853, a position tracking unit 854, a display mechanism 855, or any combination of these components. In alternative embodiments, the electronics unit 83 may be placed at various locations on or within the cricket bat 81. For example, the electronics unit 83 may be placed at locations 851, 856, 857, 858, and 859.

The electronics unit 83 captures bat motion as the batsman swings the bat 81 against an oncoming ball. In addition to capturing and storing basic motion data, such as bat swing speed, maximum bat speed, bat swing trajectory, ball and bat impact detection, time to impact, bat vertical angle at impact, the electronics unit 83 also performs intelligent signal processing and pattern recognition through the pattern recognition module 852 to perform high-level functions such as classifying segments of the captured motion and automatically tagging the segments with proper cricketing shot labels such as hook shot, sweep shot, pull shot, cover drive shot, forward defensive shot, flick shot, leg glance shot, reverse-sweep shot, switch-hit shot, scoop shot, well-left, etc.

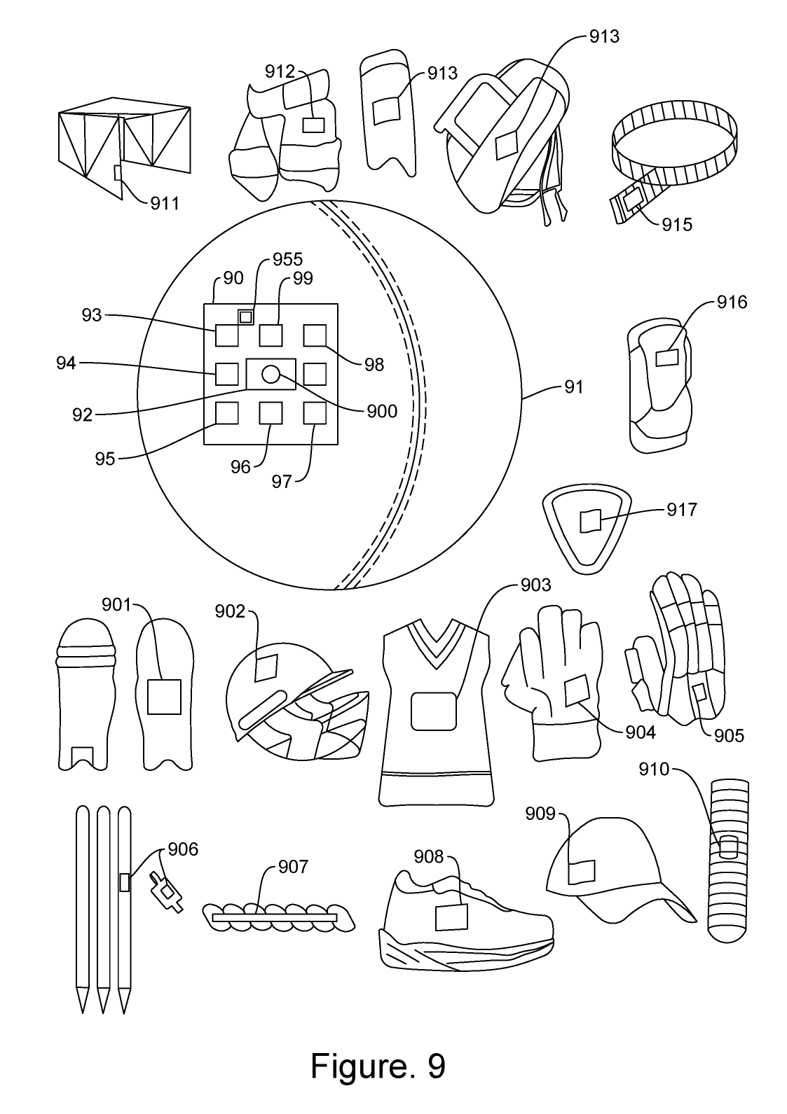

FIG. 9 shows a smart cricket ball 91 that has a built-in electronics unit 90 including sensors and a microprocessor-driven circuit board 92 in an embodiment of the present disclosure. The electronics unit 90 includes an accelerometer 93, a gyroscope 94, a magnetometer 95, a wireless communications module 96, such as a low-energy Bluetooth® module, a rechargeable battery unit 97, a memory 98, a position tracking unit 99, and a display mechanism 955. The electronics unit 90 captures ball motion as the bowler bowls the ball. In addition to capturing and storing basic motion data, such as ball speed and trajectory in the air, ball speed and trajectory after impact with the pitch (in the case of cricket), ball speed and trajectory after being hit by the batsman's bat, and spin of the ball, the electronics unit 90 also performs intelligent signal processing and pattern recognition through the pattern recognition module 900 to perform high-level functions such as classifying segments of the captured motion and automatically tagging the segments with proper cricketing bowling labels such as leg spin, topspinner, off spin, bouncer, inswinger, outswinger, reverse swing, leg cutter, off cutter, etc.

FIG. 9 also shows other smart cricket equipment with electronics units containing sensors and a processing unit tailored as per application requirements and the physical form of the cricket equipment. For example, the smart cricket equipment may include at least a portion of: a smart cricket pad containing an electronics unit 901, a smart cricket helmet containing an electronics unit 902, smart cricket clothing containing an electronics unit 903, a smart cricket wicket-keeper glove containing an electronics unit 904, a smart cricket batting glove containing an electronics unit 905, a smart cricket stump and bail containing electronics unit 906, a smart cricket boundary rope containing an electronics unit 907, a smart cricket shoe containing an electronics unit 908, a smart cricket cap containing an electronics unit 909, a smart cricket bat grip containing an electronics unit 910, a smart cricket net containing an electronics unit 911, a smart cricket thigh pad containing an electronics unit 912, a smart cricket elbow guard containing an electronics unit 913, a smart cricket kit bag containing an electronics unit 914, smart cricket tape containing an electronics unit 915, a smart cricket knee cap containing an electronics unit 916, and a smart cricket abdomen guard containing an electronics unit 917.

The electronics units may include sensory processing and communication modules. The electronics unit within each of the smart cricket equipment items enable the smart equipment items to communicate among themselves to perform group signal analysis, and to facilitate group communication among players. Furthermore, the smart cricket equipment shown in FIG. 9 as well as the smart bat illustrated in FIG. 8 collectively provide all the data to the system to enable automatic cricket game scoring and umpiring without human intervention.

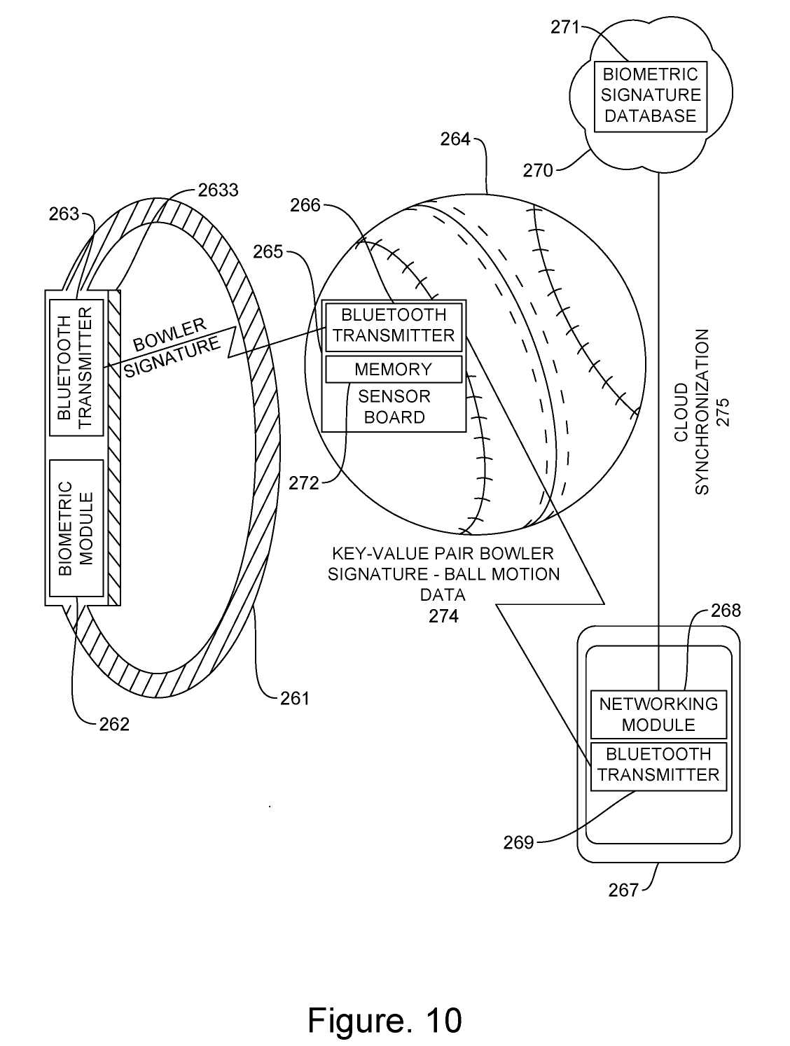

FIG. 10 shows a smart wrist band 261 containing biometric identification module 262, a wireless transmitter 263, such as a Bluetooth® transmitter, and a display mechanism 2633 in an embodiment of the present disclosure. The smart wrist band reads the wearer's fingerprint, computes a biometric signature 273 belonging to the bowler/pitcher, and transmits it to the smart cricket ball 264 via the wireless transmitter 263. The smart ball in turn stores the recordings of the bowling action or pitching action and the ball movement onto its built-in memory 272 as a value against a computed biometric signature hash 274. Essentially, the motion data pertaining to every delivery that is bowled by a particular bowler or pitched by a particular pitcher using the smart ball is saved inside the smart ball against the bowler's or pitcher's biometric signature during the duration of the game. When it is time for synchronizing the bowling motion with a portable computing device 267, such as a smartphone, the portable computing device 267 in turn runs a signature search on a global database 271 on the cloud 270. Furthermore, cloud synchronization 275 enables the system to compile an authentic database of all bowling deliveries bowled by identity-verified bowlers or pitches pitched by pitchers depending on the game.

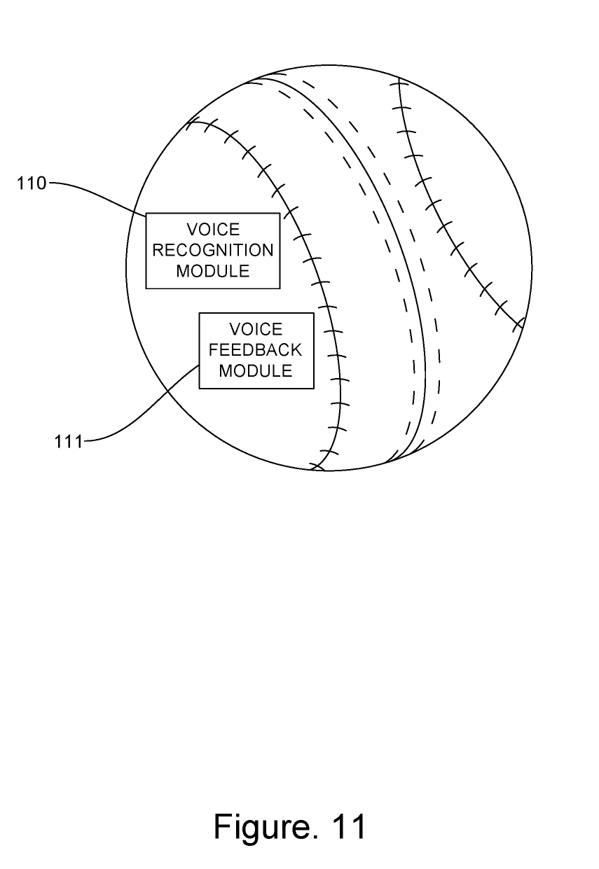

FIG. 11 shows a smart ball with voice activation module 110 and voice feedback module 111 in an embodiment of the present disclosure. The voice activation module enables a bowler to register himself as the current bowler of the smart ball during a game of cricket or enables a pitcher to register himself as the current pitcher of the smart ball during a game of baseball. The activation procedure performs voice recognition to uniquely identify an individual bowler/pitcher among the set of all bowlers/pitchers playing the game. This activation is done before the bowler/pitcher bowls/pitches each ball. The voice activation module and the voice feedback module can also be placed on other smart cricketing equipment as part of the on-board electronics units contained within the smart cricketing equipment. The voice activation module is used to uniquely identify a specific player through his use of the smart equipment through voice recognition.

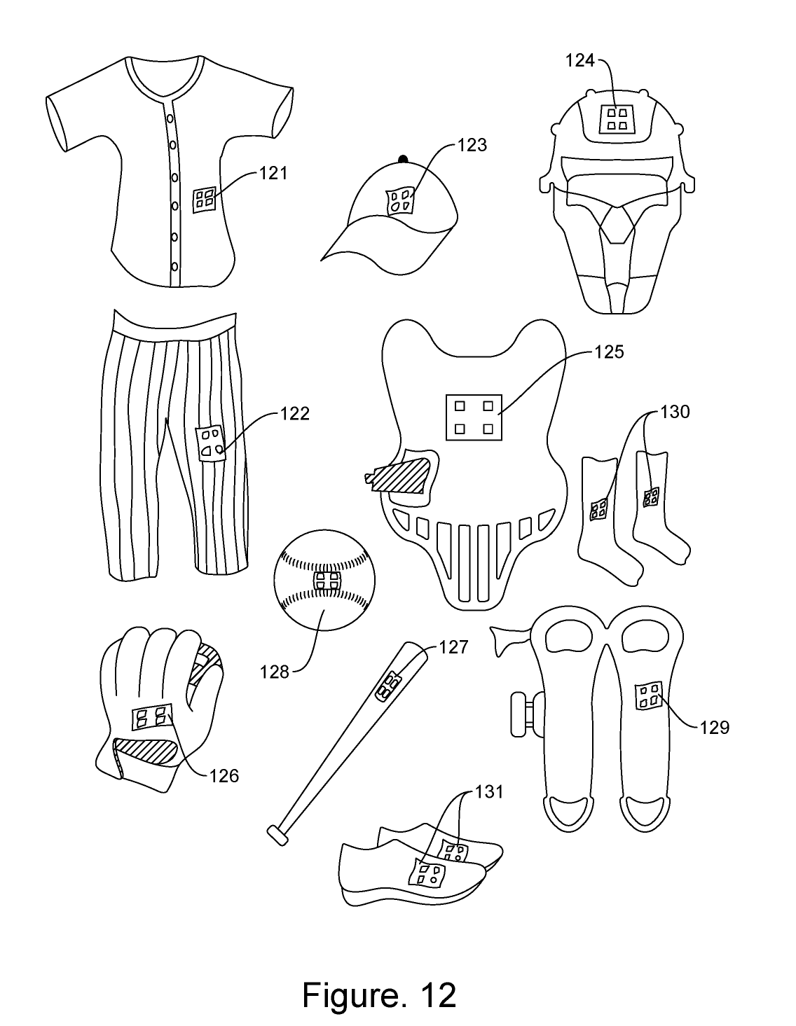

FIG. 12 shows examples of smart baseball equipment, namely, smart baseball clothing 121 and 122, a smart baseball cap 123, a smart baseball helmet 124, a smart baseball chest protector 125, a smart baseball glove 126, a smart baseball bat 127, a smart baseball ball 128, a smart baseball leg protector 129, smart baseball socks 130, and smart baseball shoes 131, each of which contains an embedded electronics unit with sensor electronics. The smart equipment provides the data necessary for the system to automatically perform high-level tasks such as baseball event tagging. The electronics unit include sensory processing and communication modules. The electronics units within each of the smart baseball equipment items enable the smart equipment items to communicate among themselves to perform group signal analysis, and to facilitate group communication among players. Furthermore, the smart baseball equipment shown in FIG. 12 collectively provide sufficient data to the system to enable automatic baseball game scoring and umpiring without human intervention.

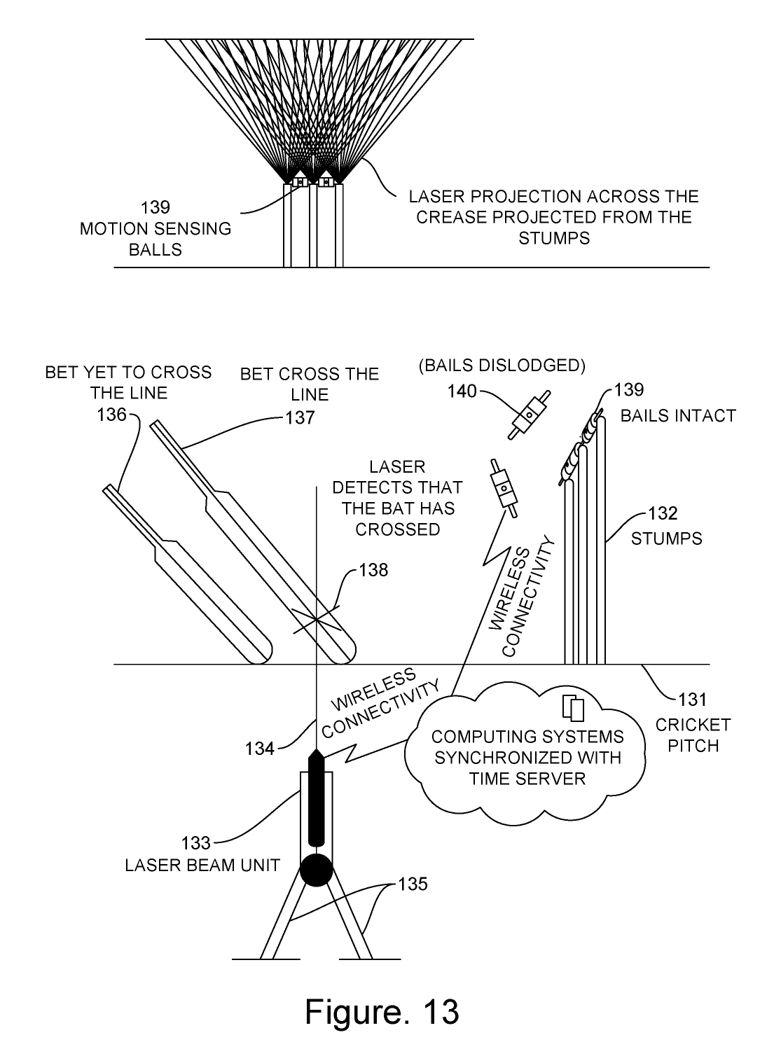

FIG. 13A shows a cricket runout detection subsystem using laser and motion sensing bails synchronized with a computing system and time server. FIG. 13A shows the pitch 131 and the stumps 132, which have bails 139, which contain an inertial measurement unit for sensing motion of the bails 139, properly placed on top of the stumps 132. A laser beam unit 133, which is mounted on stands 135, is positioned perpendicular to the pitch 131 and aligned straight with the crease. The laser beam unit 133 emits a laser beam 134 across the pitch 131. The motion sensing bails 139 and the laser beam unit 133 both contain wireless modules, enabling them to transmit and receive data and communications from computing systems present on the cloud.

FIG. 13A shows a batsman that has not yet reached the crease 136 and the batsman crossing the crease and tripping the laser 138. Tripping data from the laser beam unit 133 and the bails dislodging data from the motion sensing bails 139 are both time synchronized to detect whether it is a run-out or not. If the laser tripped before the bails being dislodged, the system registers not out; otherwise, the system registers run-out. FIG. 13B shows an alternative embodiment where the laser beam unit is embedded within the stumps, projecting the laser beam across the crease from near the top of the stumps. Again, if the laser is tripped before the bails are dislodged, the system registers not out; otherwise, the system registers run-out.

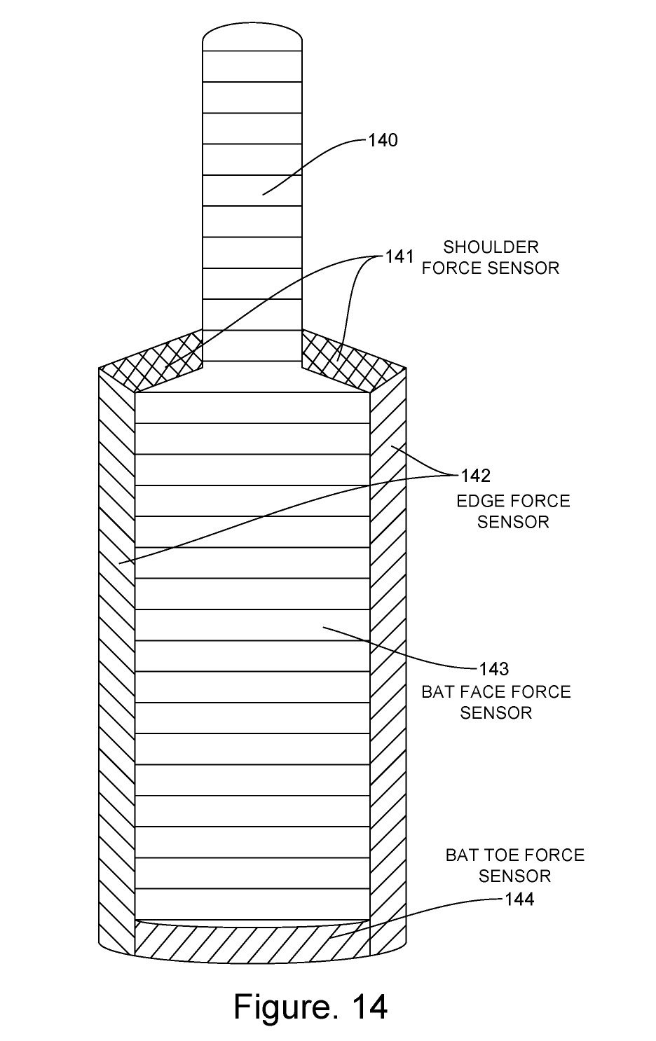

FIG. 14 shows cricket batting edge detection using force sensor strips on a smart bat 140. Shoulder force sensors 141 are disposed on the shoulder of the smart bat 140, edge force sensors 142 are disposed on the edges of the smart bat 140, face force sensors 143 are disposed on the face of the smart bat 140, and toe force sensors 144 are disposed on the toe of the smart bat 140. The force sensor strips 141-144 register impact force between the bat and the ball. Using this for data the system makes a determination as to whether there was an edge or not and may perform a task as a result of the determination.

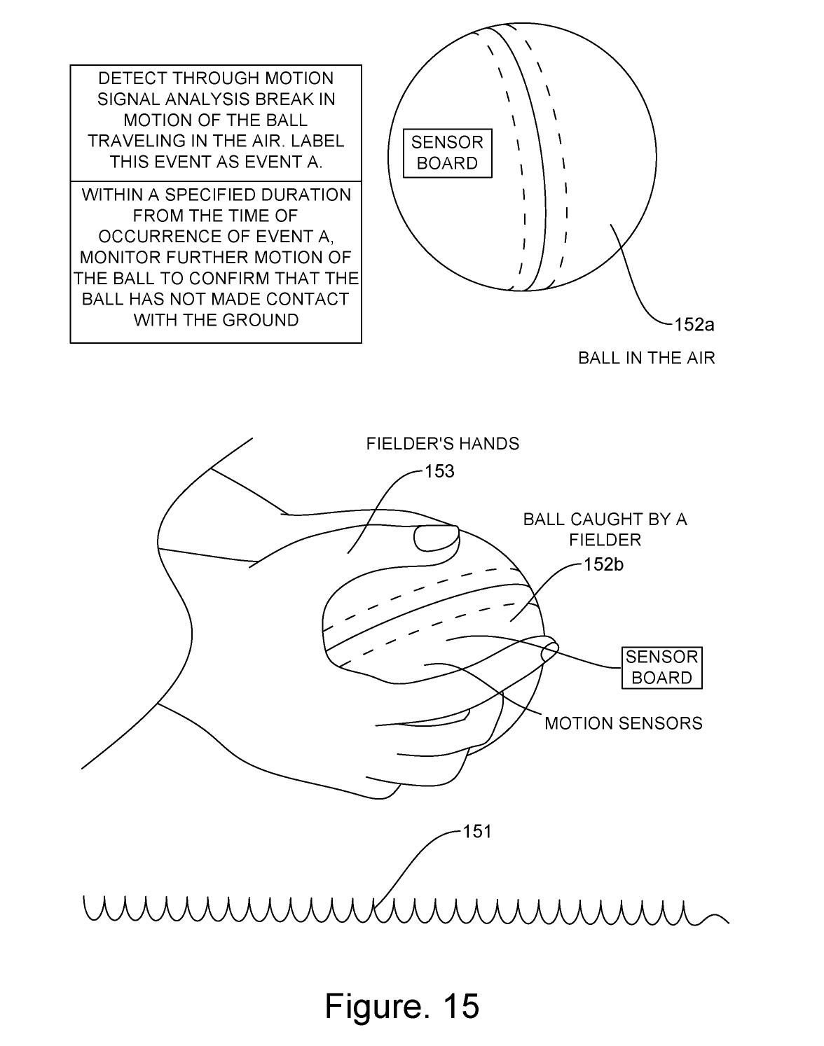

FIG. 15 shows catch detection in cricket/baseball. FIG. 15 shows a grass field reference plane 151, a ball in air 152a, a ball at the time when it is caught by a fielder, 152b, and the fielder's hands 153. In an embodiment of the present disclosure, motion sensors embedded in or on the ball capture motion data about the ball that is traveling in the air. Two primary conditions are checked by analyzing the captured motion data to determine whether a fielder has properly caught the ball:

a) The motion data suggests that there is a break in motion of the ball mid-air, enabling the system to infer that the ball has made contact with some object other than the ground.

b) Within a specified duration from the time of occurrence of event a), the ball has not made subsequent contact with the ground, enabling the system to infer that the fielder is in control of the ball without dropping it. If a catch is detected, the system determines that a batsman is caught in cricket or that a batter is out in baseball, and may perform a task as a result.

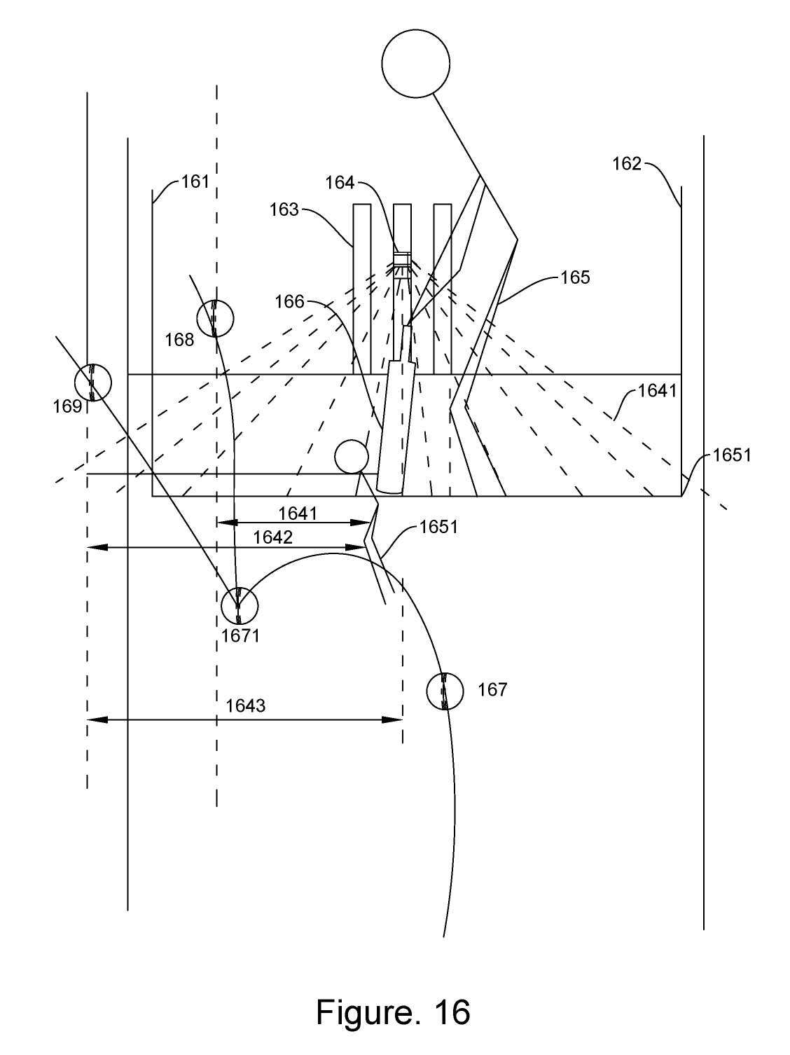

FIG. 16 shows wide detection module in cricket. FIG. 16 shows the off-side wide distance marking on the pitch 161, the leg-side wide distance marking on the pitch 162, the stumps 163, a laser beam unit 164 disposed on a stump 163, and laser beams 1641. The batsman 165 is shown standing at the crease 1651 waiting for the ball bowled by a bowler to arrive so that the batsman 165 can play a shot and strike the ball with the bat 166 that batsman 165 is holding in his hands.

FIG. 16 shows the ball in mid-air 167, the ball making contact with the ground 1671, a correctly bowled ball moving past the stumps after pitching on the ground 168, and a ball moving further past the stumps after pitching on the ground 169. The laser beam unit 164 tracks the distance 1643 between the stump and the ball as it crosses the crease. When the batsman is determined by the system to be moving towards the batsman's off-side 1651, then the distance that is calculated to make a wide-ball determination is distance 1641 (the distance between the moving batsman 1651 and the moving ball 168) or distance 1642 (the distance between the moving batsman 1651 and the moving ball 169).

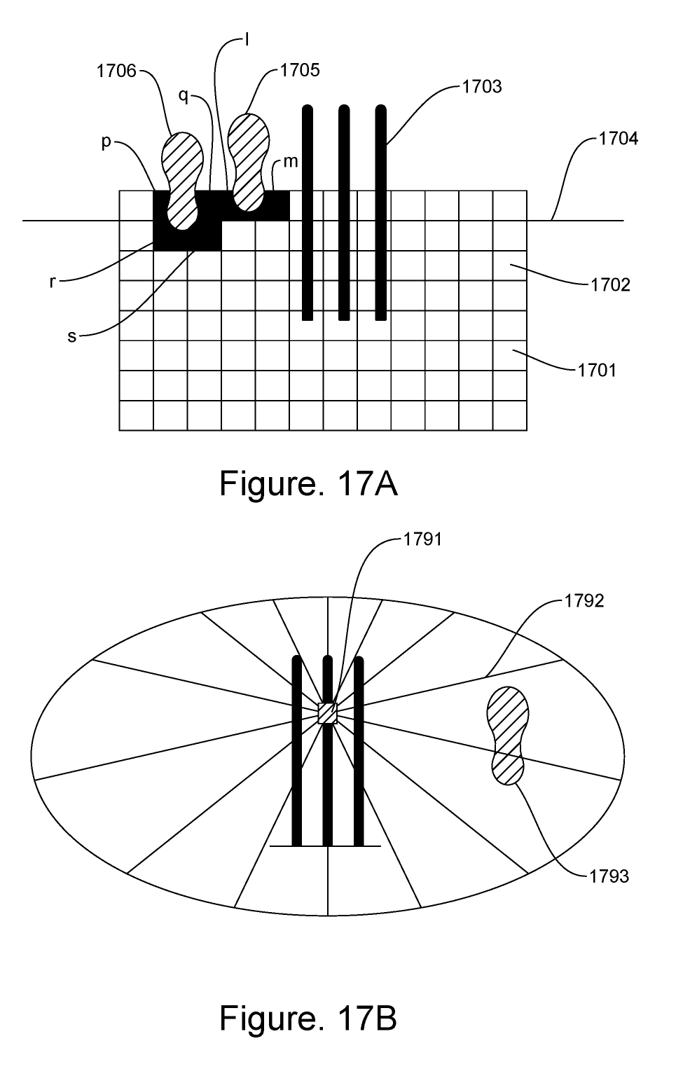

FIGS. 17A and 17B show embodiments of a no-ball detection module in cricket. In an embodiment of the present disclosure as shown in FIG. 17A, the no-ball detection module contains sensor strip 1701 including numerous sensors of small size 1702 laid out as a grid in two dimensions. The module also contains motion sensors that can accurately detect the foot when it lands on the sensor strip 1701. When a bowler lands his foot when he releases the ball, the system checks if at least one sensor that is physically located behind the bowling crease 1704 got triggered. The foot-landing associated with the release of the ball—as opposed to normal run up prior to the delivery of the ball—is determined through signal processing and gait analysis. In one scenario as shown by 1705, the bowler is deemed to have bowled a no-ball because when the bowler's landing foot landed on the sensor strip 1701, only patch 1 and patch m, which are both outside the bowling crease, got activated. In another scenario 1706, the bowler is deemed to have bowled a correct ball because when the bowler's landing foot landed on the sensor strip 1701, patches p, q, r, and s got activated out of which patches r and s lie within the bowling crease.

In another embodiment of the present disclosure as shown in FIG. 17B, the no-ball detection module contains an infrared or thermal imaging sensor 1791 that computes and monitors a heat map 1792 where the bowler lands his foot. When a bowler's foot lands on the pitch, a difference in temperature is registered 1793 by the thermal imaging camera and the heatmap is updated accordingly. This dynamic heatmap enables the system to detect the exact spot where the bowling foot lands, and to make a determination as to whether the bowling foot landed within the bowling crease or not.

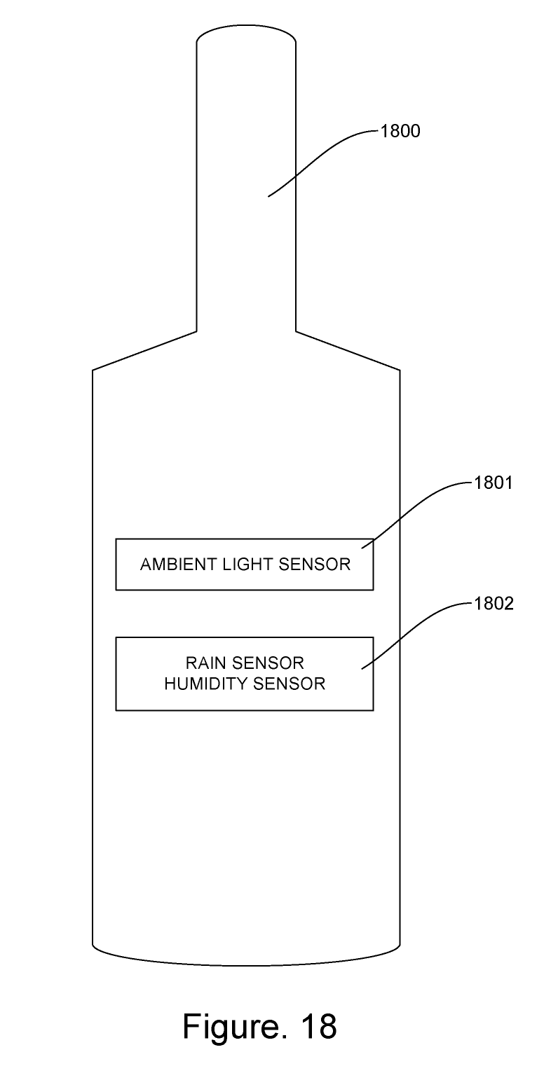

FIG. 18 shows unfavorable conditions for play detector module. This detector module detects bad light and bad weather, including rain. The detector module contains an ambient light sensor that measures the level of ambient light. If the measured light flux level is determined to be lower than the threshold for cricket game play, then the module raises “unfavorable conditions due to low light” exception. Similarly, the rain/humidity sensor determines whether there is rain or impending rain and raises an alarm “unfavorable conditions due to rain” if there is rain or impending rain.

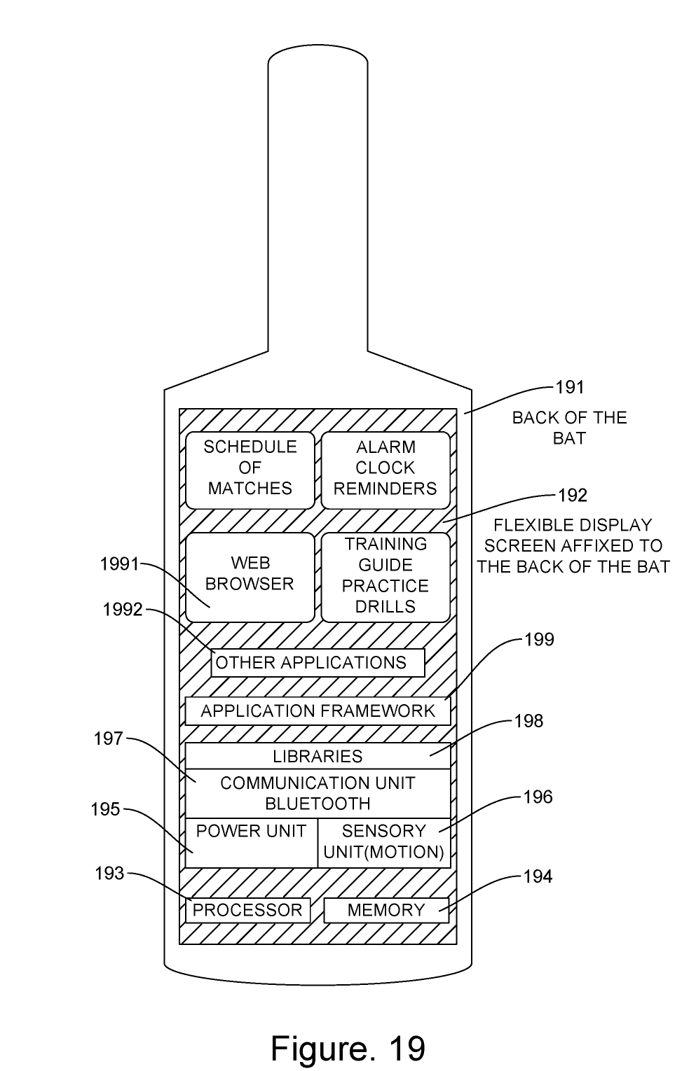

FIG. 19 shows cricket bat 191 with display screen 192. In an embodiment of the present disclosure, the cricket bat contains a built-in processor 193, memory 194, power unit 195, sensory unit 196, a communications unit 197, which may be compatible with Bluetooth®, libraries 198, kernel, applications framework 199, and applications 1992. The web browser application 1991 is used to browse web pages, as well as view cloud and online data. Other applications such as alarm, clock, reminders, calender schedule, training guide, and practice drills also run on the cricket bat. These applications can run either natively or as a web application hosted on cloud servers.

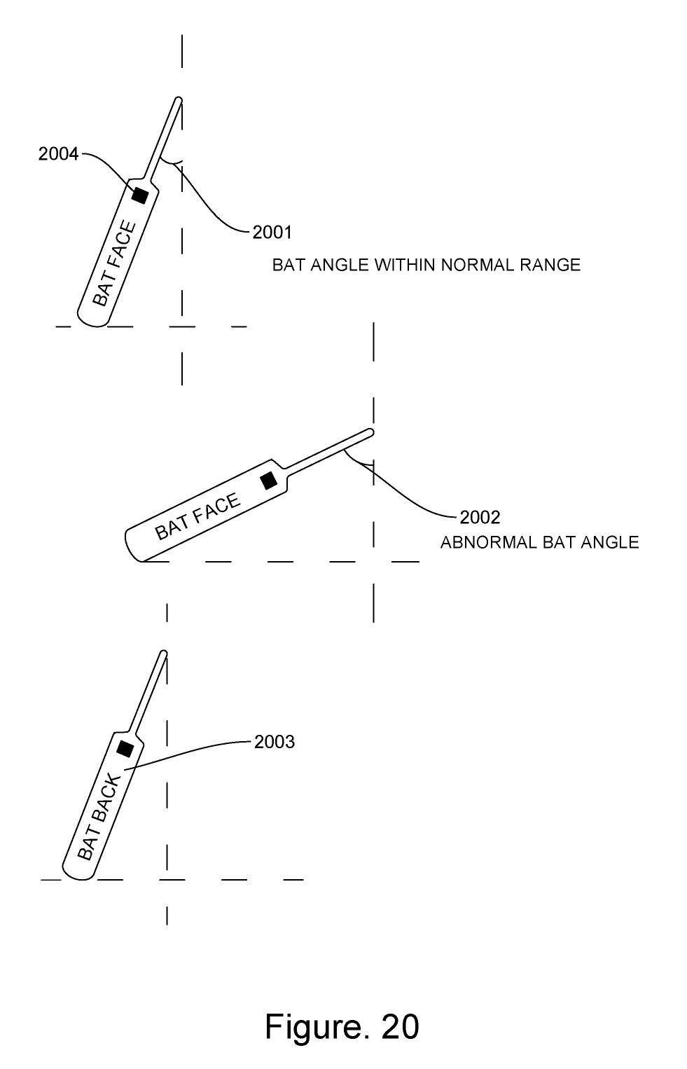

FIG. 20 shows a bat face orientation detection module in cricket. The system warns when a data point is an outlier. The accelerometer, the gyroscope, and the magnetometer motion sensors embedded onto the bat give the precise orientation and movement of the bat in three-dimensional space prior to the ball being bowled. The bat face orientation detection module warns a batsman about his batting stance if an anomalous stance is detected. The bat face orientation detection module does this by comparing the batsman's batting stance against historical data of proper batting stances through signal analysis and pattern recognition. All this may be done in relation to the pitch orientation of the ground. FIG. 20 illustrates the bat angle within normal range 2001, the bat angle with abnormal range 2002, and the batsman holding a bat incorrectly with the back of the bat facing the bowler 2003.

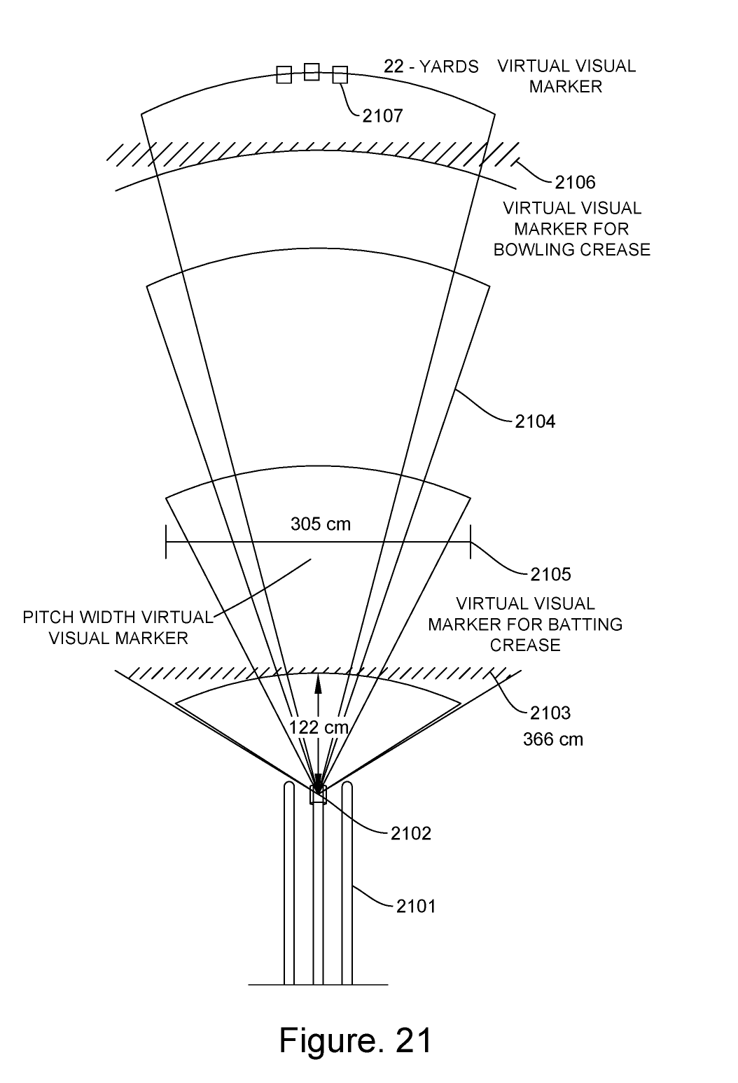

FIG. 21 shows the 22-yard pitch and crease marking stump 2101. This is useful to the players to measure a 22-yard pitch distance. The stump has a built-in laser beam unit 2102. When the stump is drilled vertically into the ground and calibrated, the stump projects laser beams at a downward angle 2104 resulting in visual laser markings along the ground up to 22 yards from the point where the stump is standing. FIG. 21 shows the virtual visual marker for the batting crease 2103, the width of the pitch 2105, the virtual visual marker for the bowling crease 2106, and the 22-yard virtual visual marker for the bowling stumps 2107.

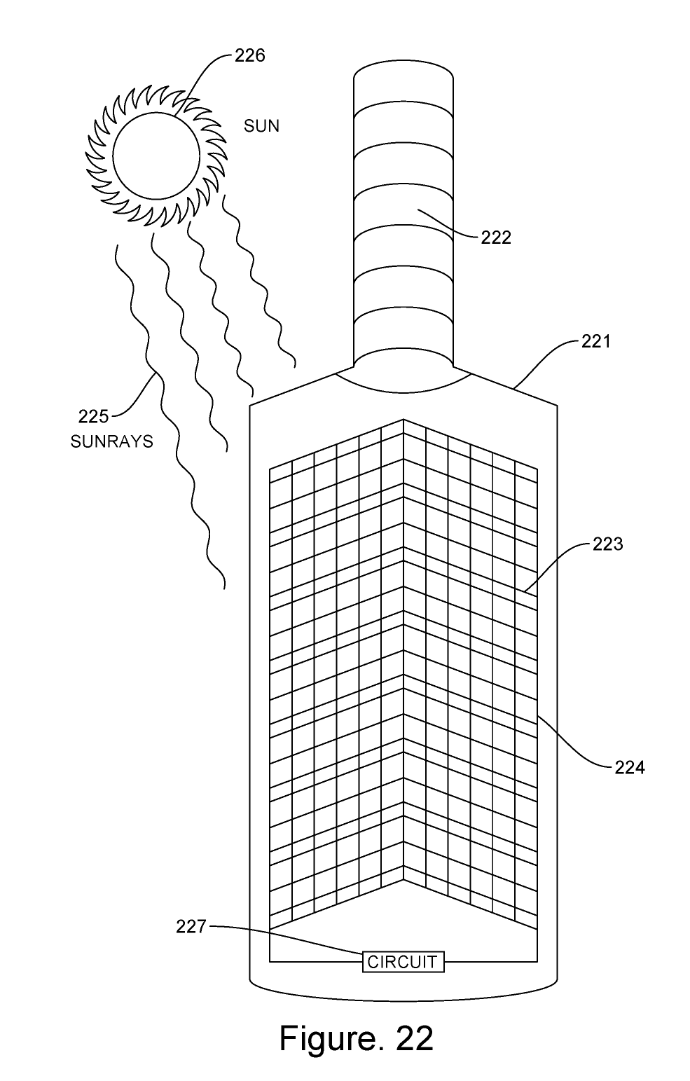

FIG. 22 shows an embodiment of a solar-powered cricket bat 221 having a handle 222 and a solar panel 224, which may be disposed on the back face 224 of the cricket bat 221. In other embodiments, the solar panel 224, which includes arrays of individual solar cells 223, may be disposed on the front face of the cricket bat 221 (not shown). The solar panel 224 may include flexible solar cells. The solar cells 223 of the solar panel 224 converts energy of sunrays 225 from the sun 226 into electricity. The electricity flows through a circuit 227, which may provide power to other electronic components disposed in or on the cricket bat 221 and/or may provide power to an energy storage device (not shown). In an alternative embodiment, the cricket bat 221 may be a baseball bat.

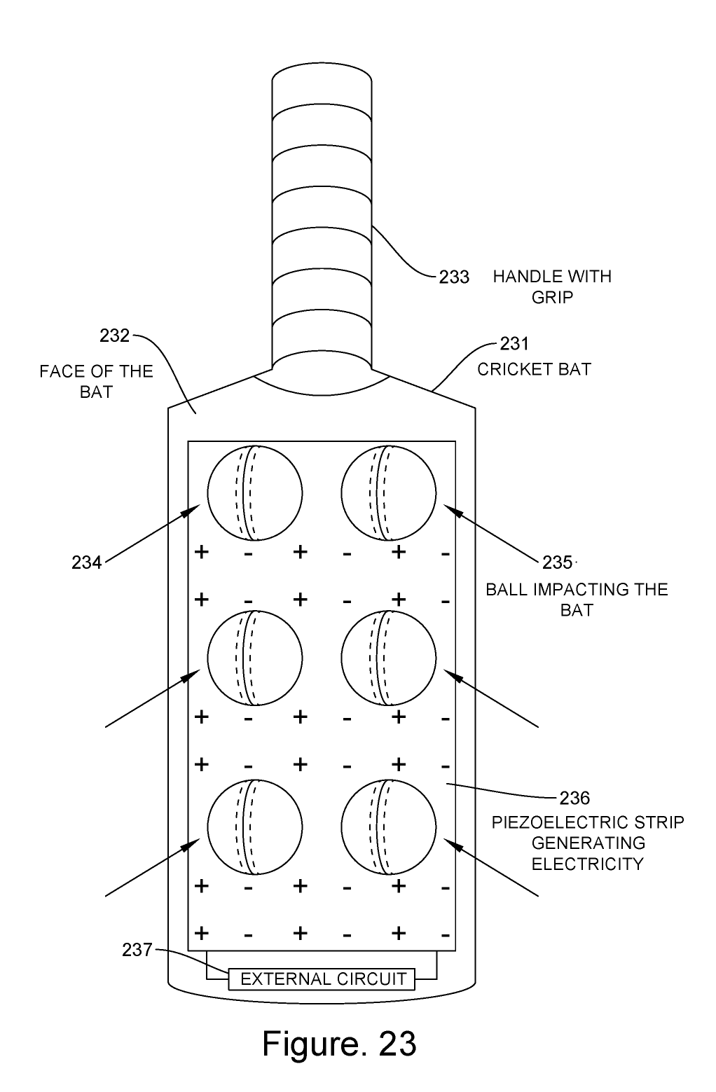

FIG. 23 shows a piezoelectric rechargeable cricket bat 231 that works based on how hard and how many times a batsman is hitting the ball. The piezoelectric rechargeable cricket bat 231 includes a handle 233, which may include a grip, and a piezoelectric strip 236 attached to the face 232 of the bat 231. When a ball impacts the cricket bat at location 235 or at location 234, for example, the piezoelectric strip 236 is stressed mechanically and generates an electrical charge, which can be collected by an external circuit 237.

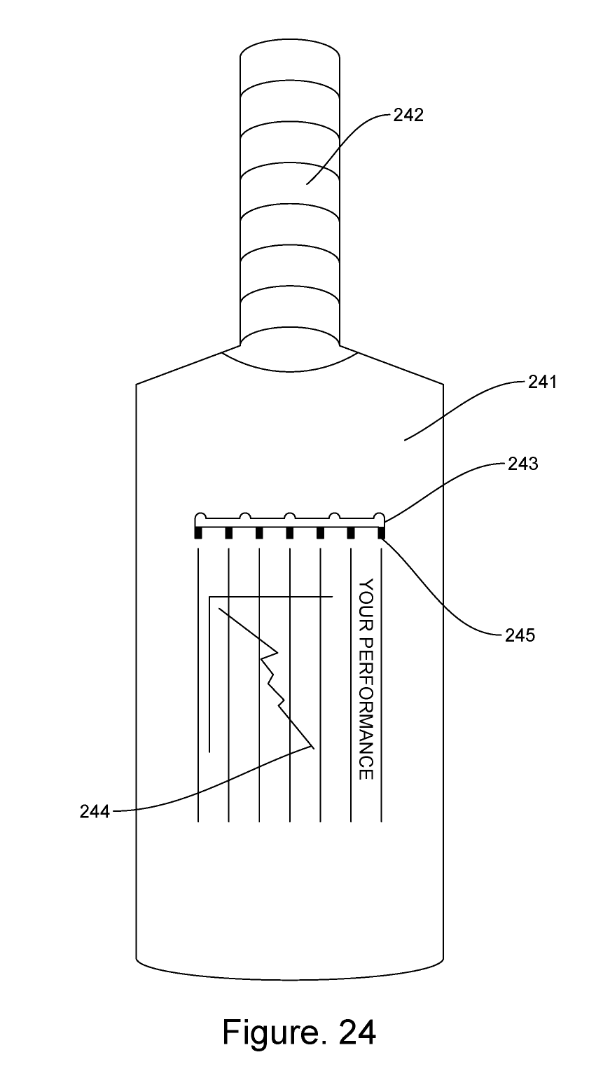

FIG. 24 shows an embodiment of a cricket bat 241 with a detachable pico projection display or display strip 243. The detachable pico projection display 243 removably attaches to the front side or the back side of the cricket bat 241. The pico projection display 243 includes a power source, projector electronics such as a processor and memory, and one or more pico projectors or light sources 245, which project an image 244 on the cricket bat 241. The projector electronics and the light sources 245 may also be configured to allow user interaction with the image 244. For example, the projector electronics and light sources 245 may detect where the user's finger blocks the light emitted from one or more of the light sources 245 and thereby determine the position of a user's finger on the image 244. The projector electronics may map the position of a user's finger on the image to a control function, e.g., when the user selects an icon in the image 244, thereby facilitating user interaction with the cricket bat 241. In embodiments, the image 244 may show the performance of the player using the cricket bat 241. The pico projection display may be detached from the cricket bat 241 when the cricket bat 241 is not being used for batting. The pico projection display may be reattached to the cricket bat 241 when the cricket bat 241 is going to be used for batting.

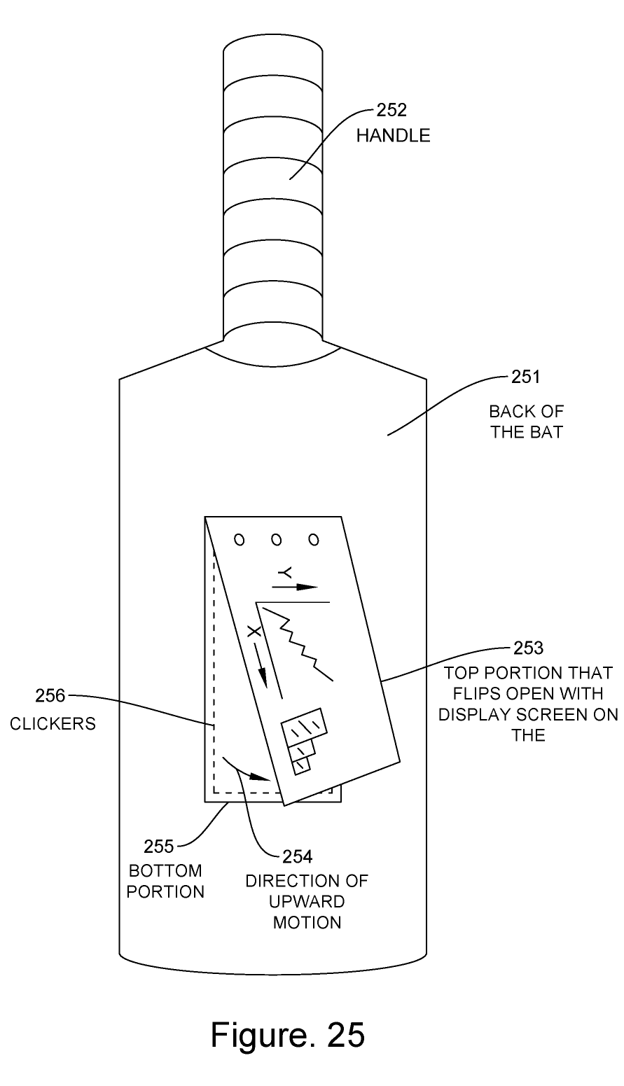

FIG. 25 shows an embodiment of a cricket bat with a foldable, flip-type display disposed on the back 251 of the cricket bat. The foldable, flip-type display includes a top portion 253 that flips open according to an upward direction of motion 254 and includes a display on the bottom portion 253. The bottom portion 255 also includes clickers 256 that maintain the top portion 253 in a closed position or snaps the top portion 253 to the bottom portion 255 unless a predetermined amount of force is applied to open the top portion 253. The foldable, flip-type configuration protects the display when the cricket bat is being used to hit a ball.

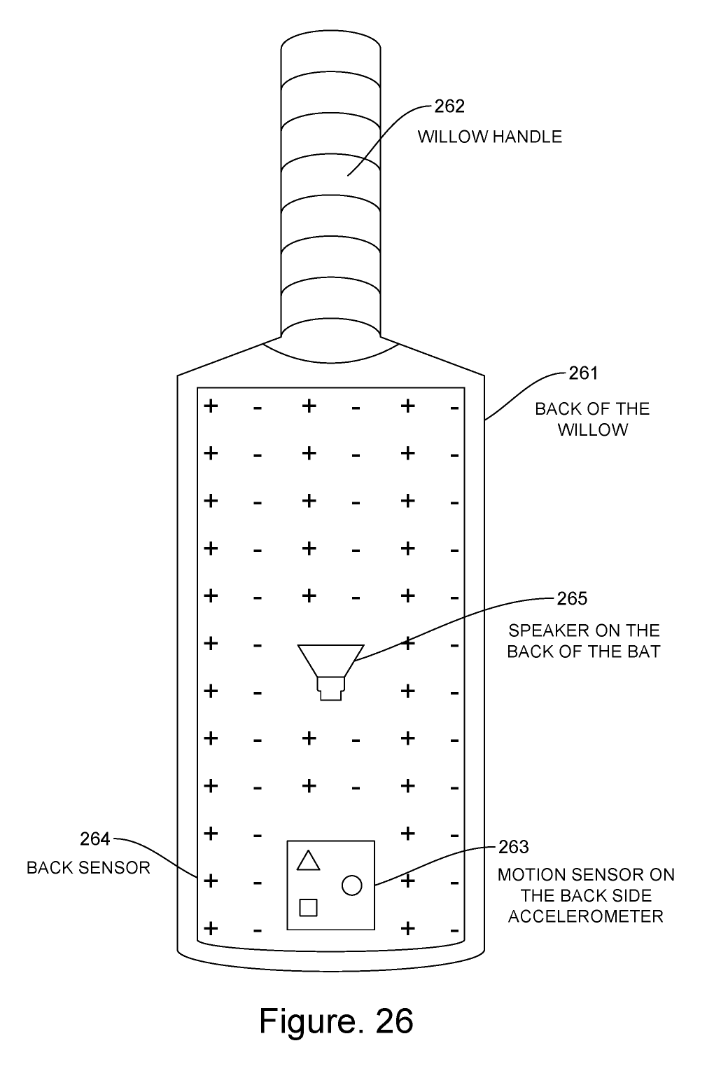

FIG. 26 shows an embodiment of an audio cricket bat which plays a song, such as “Aaluma Doluma,” after the batsman hits a ball with a force that is above a specified minimum force threshold or the batsman swings the bat according to a predetermined velocity. The audio cricket bat is made of willow and includes a willow handle 262 and a force sensor strip 264 attached to the face of the back side 261 of the willow. The audio cricket bat may also include a speaker 265 and a motion sensor disposed on the back side 261 of the willow. The motion sensor 263 may include an accelerometer for measuring acceleration (e.g., acceleration of the bat when the batter or batsman swings the bat), a gyroscope for measuring angular velocity (e.g., angular velocity of the bat when the batter or batsman swings the bat), and a magnetometer for measuring orientation with respect to the earth's magnetic field (e.g., orientation of the bat). In embodiments, if the force of the ball on the force sensor strip is greater than a predetermined threshold or the motion of the willow is greater than a predetermined threshold, an electronic device (not shown) disposed in or on the willow transmits an electrical audio signal to the speaker 265, which converts the electrical audio signal to an audible sound. The electrical audio signal may be a song, such as “Aaluma Doluma,” or one or more audio tones. For example, the song may be played when a batter hits a home run and thus acts as a reward or has the effect of applause from a crowd of people.

Sensor data from the sensors may be used to determine the force and motion of a batsman's swings and may be used to virtually create the batsman's swing on a display. For example, sensor data can be sent to a smartphone via Bluetooth® and an application running on the smartphone may create a two- or three-dimensional representation of the swing or shot or may provide an analysis of the swing or shot based on the sensor data. An application running on the smartphone may also cause the smartphone to play sounds or a song, e.g., a favorite song, based on the sensor data received from the cricket bat.

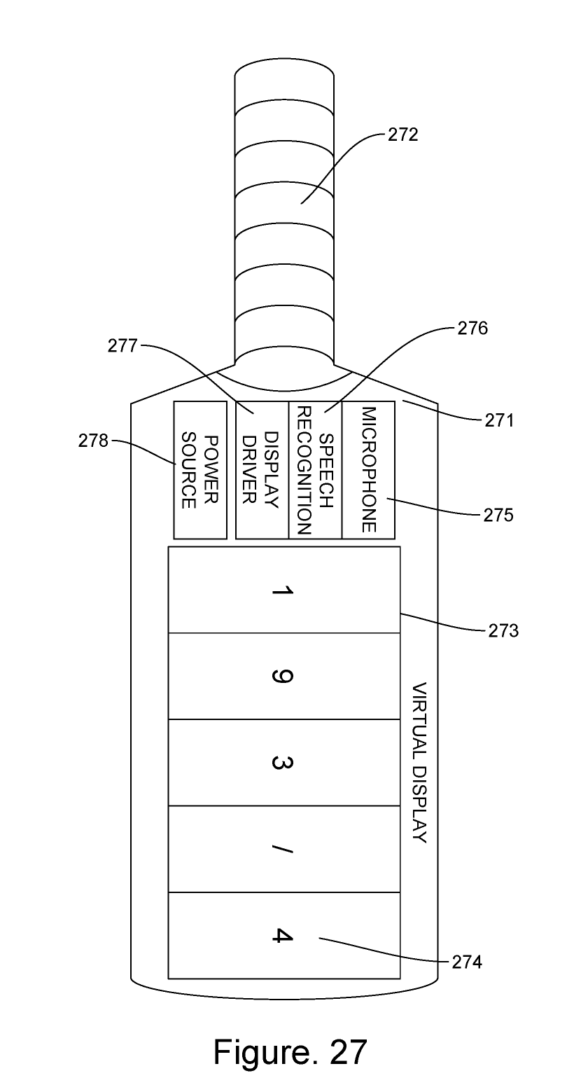

FIG. 27 shows a cricket bat 271 with running tickers that keep track of performance metrics of a player using the cricket bat 271. The cricket bat 271 includes a handle 272 and a virtual display 273 that displays performance metrics of the player using the cricket bat. The cricket bat 271 also includes a microphone 275, a speech recognition processor 276, a display driver 277, and a power source 278 for powering the microphone 275, the speech recognition processor 276, and the display driver 277. The microphone 275 converts sounds waves coming from the mouth of the user of the cricket bat 271 into an electrical audio signal. The speech recognition processor 276 converts the electrical audio signal into text, interprets the text, and causes components of the cricket bat 271 to perform a function or task based on the interpreted task. For example, the display driver 277 may cause the virtual display 273 to display all or a portion of the text.

The sound waves may include commands spoken by the user of the cricket bat 271 for causing the bat to perform a function such as to display the current score or data regarding the performance of the batsman, or to transmit sensor data to a smartphone, which can display the data regarding the performance of the batsman. The spoken commands may include a command to turn off electrical circuitry of the cricket bat 271 when the batsman is about to take a shot, and a command to turn on the electrical circuitry of the cricket bat 271 when the batsman has finished taking one or more shots shot. The sound waves may include other types of communications from the user of the cricket bat 271, which facilitate interaction with the cricket bat 271. Accordingly, there is no need for any or many physical buttons on the cricket bat 271.

In embodiments, the microphone 275 may also convert the sound waves from a person announcing the score via a loudspeaker into an electrical audio signal. The speech recognition processor 276 is electrically connected to the microphone 275 to receive the electrical audio signal from the microphone 275. The speech recognition processor 276 converts the electrical audio signal into text and, in some embodiments, extracts a cricket score from the text. If the microphone 275 receives a spoken command to show the current score, the display driver 277 may cause the virtual display 273 to display a cricket score 274, which may include the number of runs of and the number of wickets lost by the team of the player using the cricket bat 271. In this example, the number of runs is 193 and the total number of lost wickets is 4. In embodiments, the virtual display 273 may be a liquid crystal display (LCD), an inorganic light emitting diode (LED) display, an organic light emitting diode (OLED) display, a pico projection display, or any other electronic visual display that would be appropriate for the size and shape of the cricket bat 271.

The disclosed system can be adapted to perform automatic scoring and umpiring for the sports of softball, ice hockey (where a hockey stick is similar to a cricket bat and a hockey puck is similar to a ball), and field hockey as well. The foregoing description is for the purposes of illustration and description. It is not to be construed as being exhaustive or limiting the claimed subject matter. Various embodiments of the system presented are possible. The system presented here can be adapted to perform automatic scoring and umpiring of both cricket as well as baseball. The scope of the disclosure must therefore not be limited by the above description of the disclosed embodiment.

What is claimed is:

1. A system comprising:
a plurality of smart sporting equipment items, each including at least one sensor configured to capture sensor data regarding each of the plurality of smart sporting equipment items during a cricket game or a baseball game; and
a computing system in communication with the plurality of smart sporting equipment items, the computing system configured to receive the sensor data from the plurality of smart sporting equipment items, analyze the captured data using a plurality of rules for playing cricket or baseball, and automatically update a score and make umpiring determinations based on the analyzed captured data during the cricket game or the baseball game.

2. The system of claim 1, wherein the computing system synchronizes the plurality of smart equipment items used during gameplay, performs signal processing and pattern recognition on the sensor data, and performs application-level tasks for baseball or cricket including at least one of toss detection, call detection, inferring who won the toss, capturing what they chose to do first in terms of batting or fielding, identification of players, authentication of valid field state to begin game play, identification of a batsman taking guard, signaling commencement of a game, detection of a valid ball that was bowled, tracking scores, statistics, or player performance, understanding an end of an over, falling of wickets, identifying who won the game, or edge cases associated with at least one application-level task.

3. The system of claim 2, wherein the computing system performs intelligent signal processing and pattern recognition to classify segments of the sensor data and automatically tag the segments with cricketing shot labels or baseball swing labels.

4. The system of claim 3, wherein the cricketing shot labels include at least one of a hook shot, a sweep shot, a pull shot, a cover drive shot, a forward defensive shot, a flick shot, a leg glance shot, a reverse-sweep shot, a switch-hit shot, a scoop shot, or a well-left.

5. The system of claim 3, wherein the computing system performs intelligent signal processing and pattern recognition to classify segments of the sensor data and automatically tag the segments with cricket bowled ball labels or baseball pitch labels.

6. The system of claim 5, wherein the cricket bowled ball labels include at least one of a leg spin, a topspinner, an off spin, a bouncer, an inswinger, an outswinger, a reverse swing, a leg cutter, or an off cutter.

7. The system of claim 5, wherein the baseball pitch labels include at least one of a fastball, a Four-seam, a Two-seam, a Cutter, a Splitter, a Forkball, a curveball, a Slider, a Slurve, a Screwball, a Changeup, a Palmball, a Circle Changeup, or a knuckleball.

8. The system of claim 1, further comprising a camera configured to capture a field of play, positions of players, and positions of a ball,
wherein the computing system is in communication with the camera, the computing system configured to determine whether positions of players in a field of play are valid based on the plurality of rules for playing cricket or baseball, determine whether a ball thrown by a player is valid based on the positions of the ball and the plurality of rules for playing cricket or baseball, generate an audible exception if any one of the positions of players is not valid or if the positions of the ball are not valid, and update a score based on the positions of players, the positions of the ball, and the plurality of rules for playing cricket or baseball.

9. A method for automatically scoring and umpiring a cricket game or a baseball game, the method comprising:
capturing sensor data regarding a plurality of smart sporting equipment items by a plurality of sensors disposed on the plurality of smart sporting equipment items;
collecting, by a communications interface, at least a portion of the sensor data from the plurality of smart equipment items during the cricket game or the baseball game;
processing, by a computing system, the captured data based on a plurality of rules for playing cricket or baseball; and
automatically updating, by the computing system, a score and making umpiring determinations based on the processing of the captured data without a human umpire.

10. The method of claim 9, further comprising:
synchronizing smart equipment items used during the cricket game or the baseball game;
performing signal processing and pattern recognition on the at least a portion of the sensor data; and
performing application-level tasks for baseball or cricket including at least one of toss detection, call detection, inferring who won the toss, capturing what they chose to do first in terms of batting or fielding, identification of players, authentication of valid field state to begin game play, identifying a batsman taking guard, signaling commencement of a game, detecting a valid ball that was bowled, tracking the scores, understanding an end of an over, falling of wickets, identifying who won the game, or edge cases associated with at least one application-level task.

11. The method of claim 10, further comprising performing intelligent signal processing and pattern recognition to classify segments of the at least a portion of the sensor data and automatically tag the segments with shot labels.

12. The method of claim 11, wherein the shot labels are cricketing shot labels, and
wherein the cricketing shot labels are at least one of a hook shot, a sweep shot, a pull shot, a cover drive shot, a forward defensive shot, a flick shot, a leg glance shot, a reverse-sweep shot, a switch-hit shot, a scoop shot, or a well-left.

13. The method of claim 11, wherein the shot labels are baseball shot labels.

14. The method of claim 10, further comprising performing intelligent signal processing and pattern recognition to classify segments of the sensor data and automatically tag the segments with cricket bowled ball labels.

15. The method of claim 14, wherein the cricket bowled ball labels are at least one of a leg spin, a topspinner, an off spin, a bouncer, an inswinger, an outswinger, a reverse swing, a leg cutter, or an off cutter.

16. The method of claim 10, further comprising performing intelligent signal processing and pattern recognition to classify segments of the sensor data and automatically tag the classified segments with baseball pitch labels.

17. The method of claim 16, wherein the baseball pitch labels are at least one of a fastball, a Four-seam, a Two-seam, a Cutter, a Splitter, a Forkball, a curveball, a Slider, a Slurve, a Screwball, a Changeup, a Palmball, a Circle Changeup, or a knuckleball.

18. A cricket bat comprising:
a sensor configured to capture sensor data regarding the cricket bat;
a speaker or a display;
a processor coupled to the sensor and the speaker or the display, the processor configured to process the sensor data and cause the speaker to output audible sounds based on the processed sensor data or cause the display to display information based on the processed sensor data;
a transmitter configured to transmit the sensor data or the processed sensor data to a computing device; and
a power source configured to supply power to the sensor, the speaker or the display, the processor, and the transmitter.

19. The cricket bat according to claim 18, wherein the power source is at least one of a solar panel, a piezoelectric strip, or an energy storage device, and
wherein the sensor is at least one of a microphone, a motion sensor, a force sensor, an accelerometer, a gyroscope, or a magnetometer.

20. The cricket bat according to claim 19, wherein the processor performs speech recognition processing on an electrical audio signal produced by the microphone to obtain text and causes a component of the cricket bat to perform a function based on the obtained text.
